(19) United States
(12) Patent Application Publication
(10) Pub. No.: US 2003/0120878 A1
(43) Pub. Date: Jun. 26, 2003

(54) Resource sharing using a locking mechanism in a multiprocessor environment

(76) Inventors: Jens Kloster Andreassen, Lyngby (DK); Steen Vase Kock, Kpbenhavn S (DK)

Correspondence Address: KENYON & KENYON, 1500 K STREET, N.W., SUITE 700, WASHINGTON, DC, 20005, US

(21) Appl. No.: 10/024,038

(22) Filed: Dec. 21, 2001

(51) Int. Cl. G06F 13/00

(52) U.S. Cl. 711/152

(57) ABSTRACT

A locking architecture corresponding to a plurality of processors is implemented in hardware. The architecture includes a common resource having one or more memory addresses. A locking mechanism is coupled to the processors and the common resource, where the locking mechanism selectively locks the addresses based on requests from the processors. In one embodiment, the locking mechanism includes an arbiter and a locking memory. The arbiter is coupled between the processors and the common resource, and the locking memory is coupled to the arbiter. The locking memory contains addresses that have been locked.

### BACKGROUND OF THE INVENTION

1. Technical Field

The present invention generally relates to processing architectures. More particularly, the invention relates to the sharing of a common resource between multiple processors.

2. Discussion

As the demand for a feature-rich computing environment continues to grow, various architectures and systems have evolved to provide enhanced communication. For example, the communication challenges presented by the Internet have resulted in increasingly complex processing architectures. Indeed, it is becoming increasingly common for multiple processors to require access to the same memory block in order to perform internet related functions such as transmission control protocol (TCP) functions. While a number of techniques such as hyperthreading and software semaphores have evolved in order to address concerns related to multiprocessor environments, a number of difficulties remain.

In conventional computing architectures a serialization mechanism, known as a semaphore, is typically used to serialize access to a common resource. A semaphore is an integer that can vary between zero and some predetermined positive number “n”, where n is the number of requesters allowed simultaneous use of the resource. In the case of a binary semaphore, n−1 and only one requestor can use the resource at a time. Initially, the semaphore value is set at n. To obtain access to a resource, a requestor (i.e. a unit of work, such as process or a thread) tests the current value of the semaphore. If the current value is greater than zero, the requestor decrements the current value by 1 and proceeds to use the resource. If the current value is zero, on the other hand, the requester is suspended (i.e., goes to sleep) and is put in a queue as a waiter for the semaphore. To release a resource, the requestor increments the semaphore value by one. Thus, one or more bits of the common resource must be allocated to the software locking architecture in order to implement the semaphore. Such a technique is described in greater detail in U.S. Pat. No. 6,237,019 to Ault, et al.

It is important to note that by storing the semaphore value as bits of the locked resource, the resources is depleted and less room is available for the desired functionality. For example, a typical communication system might use random access memory (RAM) as a common resource, wherein the RAM contains as many as 400,000 TCP control blocks. It is easy to understand that as the size and the complexity of the system increases, available space as well as processing throughput become issues of concern.

### BRIEF DESCRIPTION OF THE DRAWINGS

The various advantages of the present invention will be come apparent to one skilled in the art by reading the following specification and appended claims, and by referencing the following drawings, in which:

FIG. 1 is a block diagram demonstrating an example of a locking architecture in accordance with one embodiment of the present invention;

FIG. 2 is a block diagram of an example of a locking mechanism in accordance with one embodiment of the present invention;

FIG. 3 is a block diagram of an example of a locking mechanism in accordance with a first alternative embodiment of the present invention;

FIG. 4 is a block diagram of an example of a locking mechanism in accordance with a second alternative embodiment of the present invention;

FIG. 5 is a block diagram of an example of a locking mechanism in accordance with a third alternative embodiment of the present invention; and

FIG. 6 is a flowchart of an example of a method of controlling access to a common resource in accordance with one embodiment of the present invention.

### DETAILED DESCRIPTION

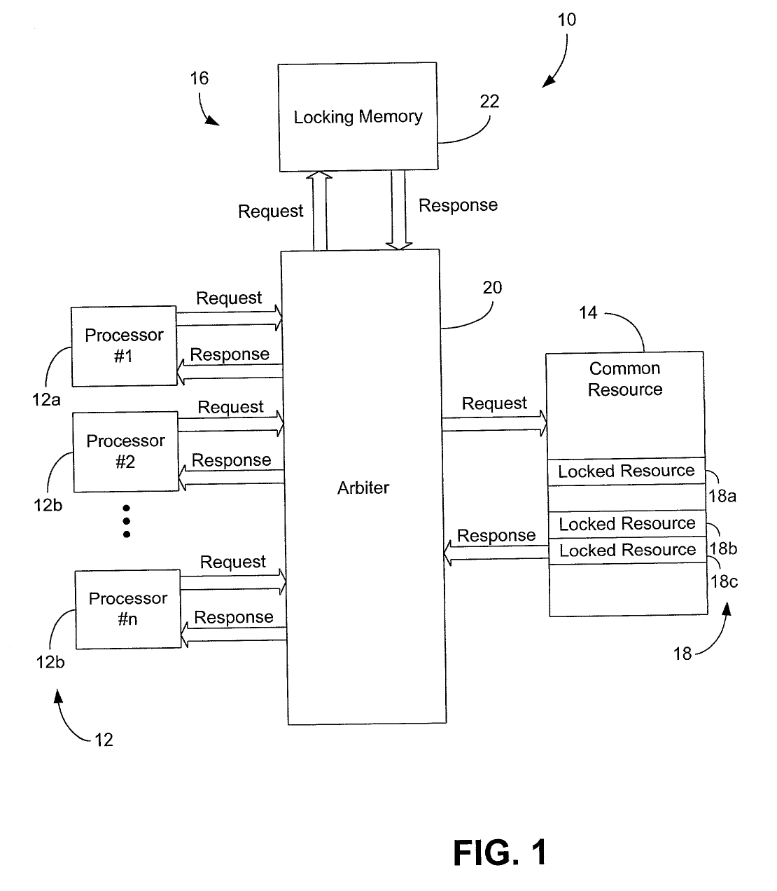

FIG. 1 shows a locking architecture 10 corresponding to a plurality of work units, processes, threads or processors 12, where the locking architecture 10 represents a significant improvement over conventional approaches. The locking architecture 10 is particularly useful in networking environments wherein a common resource stores data regarding a single networking connection. In such cases, multiple network processors may need information regarding the connection. Thus, the locking architecture 10 and/or locking mechanism 16 may be used in a multiprocessor system implemented in an application specific integrated circuit (ASIC). Generally, the locking architecture 10 includes a common resource 14 and a locking mechanism 16. The common resource 14 has one or more memory addresses associated with regions 18 of the common resource 14. The locking mechanism 16 is coupled to the processors 12 and the common resource 14, and selectively locks the addresses based on requests from the processors 12. More particularly, the locking mechanism 16 includes an arbiter 20 and a locking memory 22. The arbiter 20 is coupled between the processors 12 and the common resource 14. The locking memory 22 is coupled to the arbiter 20 and contains addresses that have been locked.

While the architecture 10 will be primarily described with regard to communication applications wherein the common resource 14 is a random access memory (RAM) storing transmission control protocol (TCP) blocks of data, the invention is not so limited. In fact, the principles described herein can be useful in any environment in which a common resource must be shared. Notwithstanding, there are a number of aspects of TCP networking for which the architecture 10 is uniquely suited.

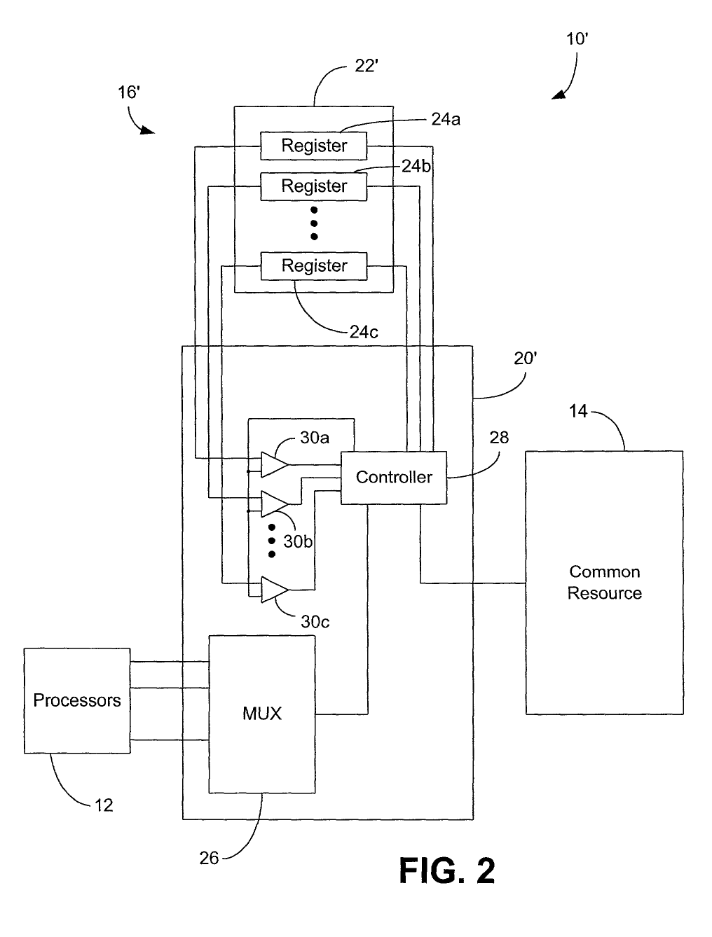

Turning now to FIG. 2, it can be seen that the locking memory 22′ may include a plurality of registers 24 to store the locked addresses. It can further be seen that a multiplexer 26 may be coupled to the processors 12, where the multiplexer 26 is to select a request from a plurality of requests. Requests may be to either read data from or write data to regions of the common resource 14. Requests may also be to either lock or unlock regions of the common resource 14. As will be discussed below, requests will typically include the address of the desired region to be accessed. Any number of techniques, such as “round-robin” selection, may be used to obtain the selected request.

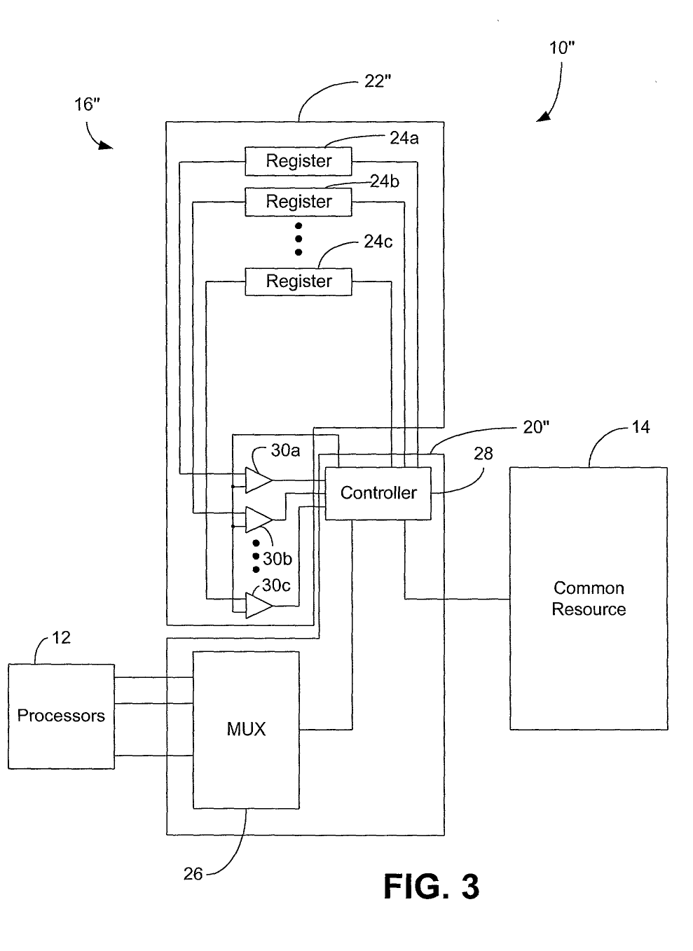

It can be seen that a controller 28 is coupled to the multiplexer 26, where the controller 28 determines a requested address based on the selected request. Any number of well documented parsing or filtering techniques can be used to obtain the requested address. It will further be appreciated that a plurality of comparators 30 are coupled to the controller 28 and the registers 24 in order to provide a parallel approach to determining whether the address has already been locked. If any of the comparators return a true signal based on the comparison, the controller 28 determines that the address is already locked and responds accordingly. It should be noted that FIG. 2 illustrates an approach wherein the comparators 30 are incorporated as part of the arbitrator 20′. FIG. 3, on the other hand, shows that the comparators 30 may also be incorporated as part of the locking memory 22″. In such case, the arbiter 20″ includes the controller 28 and the multiplexer 26 and delegates the comparison to the locking memory 22″.

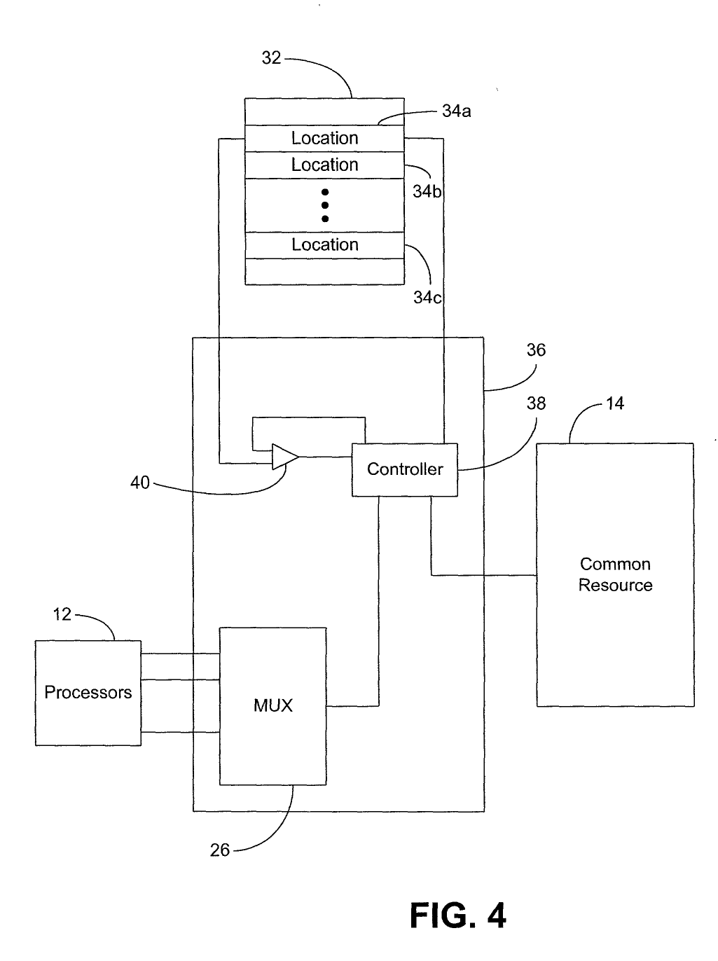

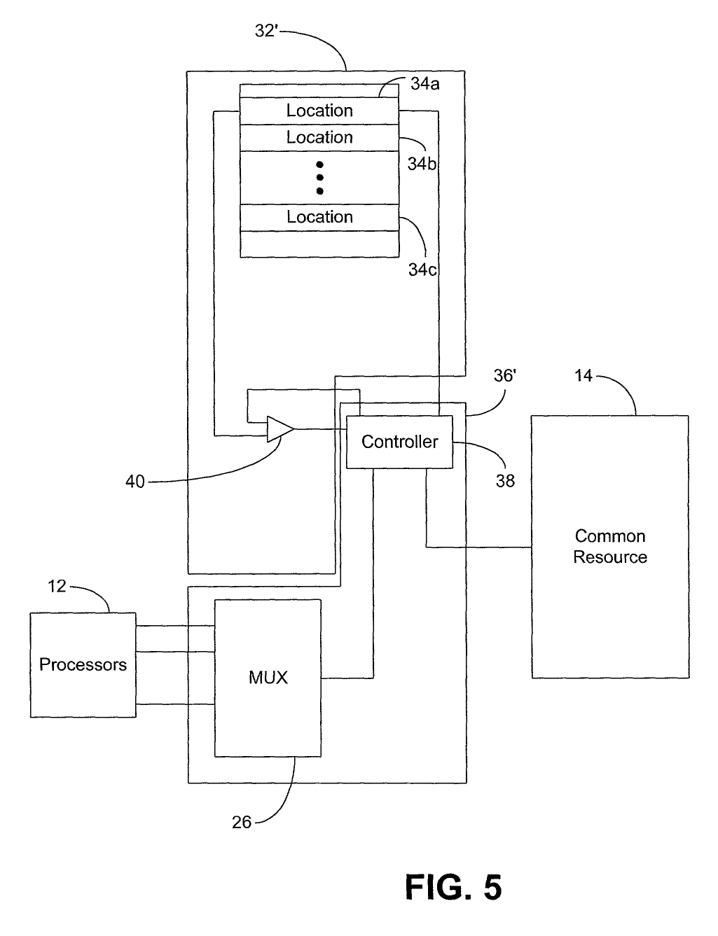

FIGS. 4 and 5 demonstrate that the locking memory 32 may alternatively include a memory region, such as RAM, having a plurality of locations 34 to store the locked addresses. In such case, the arbiter 36 would still include a controller 38 coupled to the multiplexer 26. The controller 38, on the other hand, determines a requested address based on the selected request and queries each of the locations 34 in response to the selected request. A comparator 40 is coupled to the controller 38 and the locking memory 32, where the comparator 40 compares a content of each of the locations 34 with the requested address. Although the illustrated approach is serial in nature, certain processing benefits may be achieved through the use of well documented RAM techniques such as direct memory access (DMA) and others.

Turning now to FIG. 5, it can be seen that the comparator 40 can alternatively be incorporated as part of the locking memory 32′ as opposed to the arbiter 36′. It should also be noted that the approaches described herein are primarily implemented with hardware, and yield a much higher performance compared to a system that uses software semaphores to control access to a shared resource. The performance benefits are particularly noticeable when the common resource is relatively large. Furthermore, the software supporting the hardware approach described herein is significantly simpler than the software required to implement semaphores.

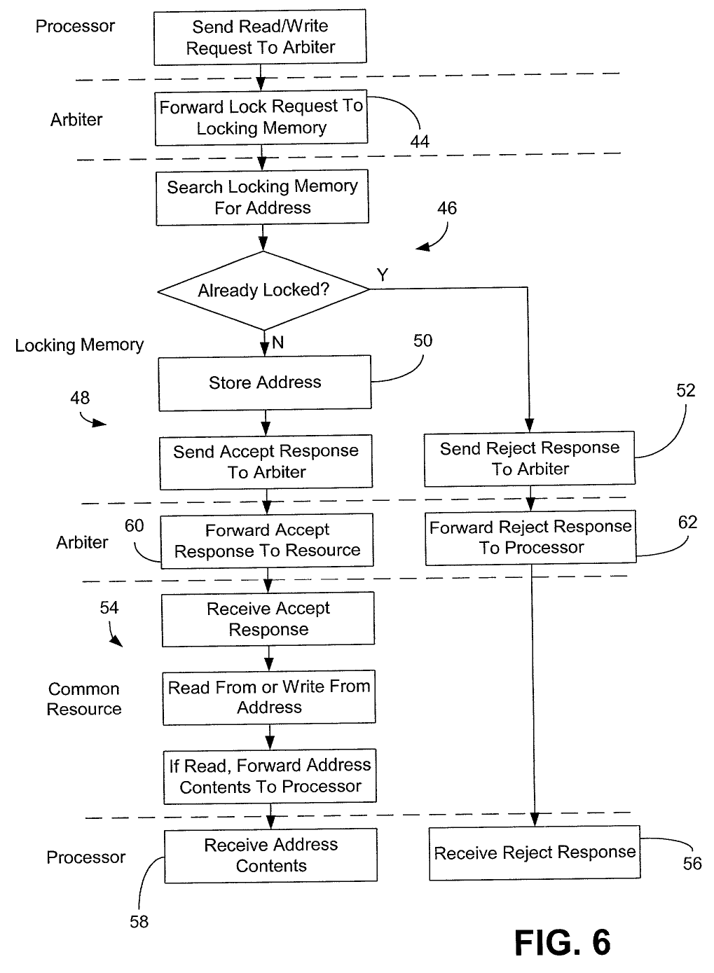

Turning now to FIG. 6, a method 42 of controlling access to a common resource is shown. Thus, the operation of the locking architecture 10 and locking mechanism 16 (FIGS. 1-5) can be better understood with reference to the method 42 shown in FIG. 6. Generally, a request to access the common resource is received and forwarded at processing block 44, where the request has a corresponding requested address. Processing blocks 46 provide for determining whether the requested address is stored in the locking memory. It can be seen that access to the requested address is granted at processing blocks 48 when the requested address is not stored in the locking memory. Specifically, processing block 50 provides for storing the requested address in the locking memory. It can further be seen that access to the requested address is denied at processing block 52 when the requested address is already stored in the locking memory. It should be noted that the request received from the processor can be either a read or write request as best illustrated at processing blocks 54.

Thus, a processor is a unit that can request access to data from a memory device and operate on that data. As already mentioned, a request can be a lock request or an unlock request. Although the steps illustrated in FIG. 6 primarily relate to lock requests, it will be appreciated that a similar flow, although somewhat simplified, can be used to unlock memory addresses. A lock request would normally also be a request for reading the data from (or writing the data to) the region in the common resource. The request from the processor will always contain an address identifying the memory space that the processor wants to access. The processor can receive either an accept response (processing block 58) from the arbiter or a reject response (processing block 56). It can be seen that data from the common resource may be returned to the processor in the accept response. If the processor receives a reject response from the arbiter, the requested data was locked by another processor. In such case, the processor must issue another request to the arbiter.

The arbiter receives requests from a number of processors and arbitrates among these processors. Upon receiving a read/write request from a processor, the arbiter will forward the request to the locking memory (processing block 44). The response from the locking memory can be an accept response or a reject response. If the response from the locking memory block is an accept response, the request from the processor is forwarded to the common resource at processing block 60. If the locking memory block is a reject response, the arbiter will forward the reject response to the processor at processing block 62 and nothing related to that request is forwarded to the common resource. Responses from the common resource are always forwarded to the requesting processor.

The locking memory contains all addresses that have been locked by each processor. The locking memory receives requests for locking or unlocking an address space from the arbiter. The size of each locked space is a system parameter and is not stored in the locking memory. As already discussed, if the request from the arbiter is a lock request, the locking memory can respond with an accept response or a reject response. If another processor has already locked the space in the common resource, the response to a lock request will be a reject response. If no other processor has locked the space in the common resource, the response to a lock request will be an accept response. When the locking memory receives an unlock request, the corresponding space address value stored in the locking memory is removed, allowing other processor to lock and access the space.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims.

What is claimed:

1. A locking architecture corresponding to a plurality of processors, the architecture comprising:
a common resource having one or more memory addresses;
a locking mechanism coupled to the processors and the common resource, the locking mechanism to selectively lock the addresses based on read requests from the processors.

2. The locking architecture of claim 1 wherein the locking mechanism includes:
an arbiter coupled between the processors and the common resource; and
a locking memory coupled to the arbiter, the locking memory to contain addresses that have been locked.

3. The locking architecture of claim 2 wherein the arbiter is to lock addresses by storing them in the locking memory.

4. The locking architecture of claim 2 wherein the locking memory includes a plurality of registers to store the locked addresses.

5. The locking architecture of claim 4 further including:
a multiplexer coupled to the processors, the multiplexer to select a request from a plurality of requests;
a controller coupled to the multiplexer, the controller to determine a requested address based on the selected request; and
a plurality of comparators coupled to the controller and the registers, each comparator to compare a content of a corresponding register with the requested address.

6. The locking architecture of claim 5 wherein the comparators are incorporated as part of the arbiter.

7. The locking architecture of claim 5 wherein the comparators are incorporated as part of the locking memory.

8. The locking architecture of claim 2 wherein the locking memory includes a memory region having a plurality of locations to store the locked addresses.

9. The locking architecture of claim 8 further including:
a multiplexer coupled to the processors, the multiplexer to select a request from a plurality of requests;
a controller coupled to the multiplexer, the controller to determine a requested address based on the selected request and to query each of the locations in response to the selected request; and
a comparator coupled to the controller and the locking memory, the comparator to compare a content of each of the locations with the requested address.

10. The locking architecture of claim 9 wherein the comparator is incorporated as part of the arbiter.

11. The locking architecture of claim 10 wherein the comparator is incorporated as part of the locking memory.

12. The locking architecture of claim 1 wherein the common resource includes a random access memory (RAM).

13. The locking architecture of claim 1 wherein the memory addresses of the common resource correspond to control blocks.

14. The locking architecture of claim 13 wherein the control blocks are transmission control protocol (TCP) blocks.

15. A locking mechanism comprising:
an arbiter coupled between a plurality of processors and a common resource; and
a locking memory coupled to the arbiter, the locking memory to contain addresses that have been locked.

16. The locking mechanism of claim 15 wherein the arbiter is to lock addresses by storing them in the locking memory.

17. The locking mechanism of claim 15 wherein the locking memory includes a plurality of registers to store the locked addresses.

18. The locking mechanism of claim 17 further including:
a multiplexer coupled to the processors, the multiplexer to select a request from a plurality of requests;
a controller coupled to the multiplexer, the controller to determine a requested address based on the selected request; and
a plurality of comparators coupled to the controller and the registers, each comparator to compare a content of a corresponding register with the requested address.

19. The locking mechanism of claim 15 wherein the locking memory includes a memory region having a plurality of locations to store the locked addresses.

20. The locking mechanism of claim 19 further including:
a multiplexer coupled to the processors, the multiplexer to select a request from a plurality of requests;
a controller coupled to the multiplexer, the controller to determine a requested address based on the selected request and to query each of the locations in response to the selected request; and
a comparator coupled to the controller and the locking memory, the comparator to compare a content of each of the locations with the requested address.

21. A locking architecture corresponding to a plurality of processors, the architecture comprising:
a random access memory (RAM) having one ore more memory addresses, the memory addresses corresponding to control blocks;
an arbiter coupled between the processors and the RAM; and
a locking memory coupled to the arbiter, the locking memory to contain addresses that have been locked, the arbiter to lock addresses by storing them in the locking memory.

22. The locking architecture of claim 21 wherein the locking memory includes a plurality of registers to store the locked addresses.

23. The locking architecture of claim 21 wherein the locking memory includes a memory region having a plurality of locations to store the locked addresses.

24. A method of controlling access to a common resource, the method comprising:
receiving a request to access the common resource, the request having a corresponding requested address;
determining whether the requested address is stored in a locking memory; and
granting access to the requested address when the requested address is not stored in the locking memory.

25. The method of claim 24 further including storing the requested address in the locking memory.

26. The method of claim 24 further including denying access to the requested address when the requested address is stored in the locking memory.

27. The method of claim 24 further including:
receiving a plurality of requests; and
selecting the request from the plurality of requests.

28. The method of claim 27 further including receiving a plurality of read requests.

29. The method of claim 27 further including receiving a plurality of write requests.
